(19) United States
(12) Patent Application Publication
(10) Pub. No.: US 2009/0110523 A1
(43) Pub. Date: Apr. 30, 2009

(54) Tilt deck vehicle with rear impact guard ramp

(75) Inventors: Gerald Geoffrion, Gravelbourg (CA); Brian Ogle, Gravelbourg (CA)

Correspondence Address: NIXON & VANDERHYE, PC, 901 NORTH GLEBE ROAD, 11TH FLOOR, ARLINGTON, VA, 22203, US

(73) Assignee: TRAILTECH INC., Gravelbourg (CA)

(21) Appl. No.: 12/004,100

(22) Filed: Dec. 20, 2007

(30) Foreign Application Priority Data
Oct. 29, 2007 (CA) 2,608,520

(51) Int. Cl. B60P 1/04

(52) U.S. Cl. 414/480; 410/3

(57) ABSTRACT

A vehicle has a frame supported on wheels. A tilt deck is pivotally attached to a rear of the frame. A deck latch locks the tilt deck to the frame in the transport position. A ramp pivotally attached to the deck moves from an inclined position, where the ramp slopes downward and a rear end of the ramp is a desired distance above the ground, to an aligned position aligned with the deck. A ramp latch locks the ramp to the tilt deck in the inclined position. The apparatus is configured such that when the deck latch is released the rear end of the tilt deck moves down until the rear end of the ramp rests on the ground. Releasing the ramp latch allows the tilt deck to move downward and the ramp can move to the aligned position in response to a downward force exerted on the ramp.

This invention is in the field of trailers and in particular a trailer with a ramp for loading tracked or wheeled equipment.

### BACKGROUND

Vehicles such as trucks and trailers for loading and transporting equipment and machines are well known in the transportation industry. Such vehicles typically have a flat deck for carrying the machine, and a ramp at the rear end to facilitate driving the machine onto the deck. Low boy trailers have a deck that is located between the trailer wheels and so is much lower to the ground than standard trucks and trailers where the deck is located above the wheels. The deck on a standard vehicle can thus be the full width of the vehicle, however the deck is then much higher above the ground than that of a low boy trailer, and the ramp incline and/or length must be significantly increased.

In addition with a fixed deck vehicle there is a corner at the point where the ramp, which is inclined, meets the rear end of the horizontal deck. Where equipment being loaded has a low clearance, the underside of the equipment may contact the corner as the forward wheels move along the horizontal deck while the rearward wheels are still on the ramp. As the ramp length increases for a given height from the ground, the angle between the deck and the ramp decreases and the clearance problem is reduced. As one solution, folding ramps have been developed in order to provide a longer ramp that can be folded for storage. Such a folding ramp is disclosed for example in U.S. Pat. No. 6,386,819 to Schultz.

In order to facilitate loading, transport vehicles have also been developed where the deck itself tilts to form the ramp, or a portion thereof. In some trailers this is accomplished by providing a sliding deck trailer where the deck is moved rearward along the vehicle frame, and then the rear end of the deck is lowered to form a ramp, as disclosed for example in U.S. Pat. No. 6,461,096 to Mentele et al. Alternatively it is also known to provide a sliding axle trailer where the rear vehicle wheels move forward in order to allow the rear end of the deck to be lowered to form a ramp, such as is disclosed in U.S. Pat. No. 6,036,207 to Oehlerking et al. The tilting decks of Mentele and Oehlerking also include a small ramp section that folds out from the rear end of the trailer.

U.S. Pat. No. 6,733,219 to Floe discloses a tilt deck trailer where wheels are attached to the deck and a hitch tongue is pivotally attached to a front portion of the deck forward of the wheels. The deck tilts down at the rear about the wheels, thereby raising the front end of the deck and the hitch tongue. A ramp at the rear of the deck also folds down to extend the deck when tilted. A leg on the ramp supports the rear end of the deck and the ramp so that they are aligned. A wheeled vehicle is driven onto the tilted deck, and then the deck tilts down to a level transport position and is locked, and the ramp is folded up.

As a safety feature, many jurisdictions require that an impact zone at the rear end of all vehicles be no more than a maximum height above the ground in order to prevent low vehicles like cars from passing under the rear end during a crash. If the hood of a car passes under the rear end of a highway trailer, for example, the windshield and passenger compartment will contact the trailer, rather than the bumper, greatly increasing the risk of injury to occupants of the car. Thus relatively high vehicles such as trucks and trailers must provide a rear impact guard that is typically no higher than about 20 inches above the ground. This guard can be provided by a steel framework fixed to the vehicle frame. Providing this guard is a design feature that must be considered when providing ramps and the like for loading equipment onto flat deck trailers, and can be problematic where folding ramps are desired.

### SUMMARY OF THE INVENTION

It is an object of the present invention to provide a vehicle with a tilting deck and attached loading ramp that overcomes problems in the prior art.

In a first embodiment the present invention provides a tilt deck vehicle apparatus comprising a frame supported on wheels for travel along the ground in an operating travel direction. A tilt deck is pivotally attached at a middle portion thereof to a rear portion of the frame about a deck pivot axis such that the tilt deck is supported on the frame for transport on the wheels when the tilt deck is in a substantially horizontal transport position. A deck latch is operative to selectively lock the tilt deck to the frame in the transport position. A ramp is pivotally attached at a front end thereof to a rear end of the tilt deck about a ramp pivot axis and is movable from an inclined position, where the ramp slopes downward from the front end thereof such that a rear end of the ramp is a desired distance above the ground, to an aligned position where a top surface of the ramp is substantially aligned with a top surface of the tilt deck. A ramp latch is operative to selectively lock the ramp to the tilt deck in the inclined position. The frame, tilt deck, and ramp are configured such that when the deck latch is released the rear end of the tilt deck moves down from the transport position until the rear end of the ramp rests on the ground. When the ramp latch is released, the rear end of the tilt deck can move downward such that the ramp can move to the aligned position in response to a downward force exerted on the ramp.

In a second embodiment the present invention provides a method of providing a rear impact guard and ramp on a tilt deck vehicle. The method comprises providing a frame supported on wheels for travel along the ground in an operating travel direction; providing a tilt deck pivotally attached at a middle portion thereof to a rear portion of the frame about a deck pivot axis such that the tilt deck is supported on the frame for transport on the wheels when the tilt deck is in a substantially horizontal transport position; providing a deck latch operative to selectively lock the tilt deck to the frame in the transport position; providing a ramp pivotally attached at a front end thereof to a rear end of the tilt deck about a ramp pivot axis and movable from an inclined position, where the ramp slopes downward from the front end thereof, to an aligned position where a top surface of the ramp is substantially aligned with a top surface of the tilt deck; providing a rear impact guard at a rear end of the ramp and configuring the ramp such that the rear impact guard is a desired distance above the ground; providing a ramp latch operative to selectively lock the ramp to the tilt deck in the inclined position; configuring the frame, tilt deck, and ramp such that when the deck latch is released the rear end of the tilt deck moves down from the transport position until the rear end of the ramp rests on the ground; and wherein releasing the ramp latch allows the rear end of the tilt deck to move downward such that the ramp can move to the aligned position in response to a downward force exerted on the ramp.

By releasably securing the ramp in an inclined orientation, a rear impact guard incorporated into the end of the ramp can be located at a desired height off the road to properly locate the rear impact guard as required by road regulations. Releasing the ramp latch when the deck tilts allows the ramp to move into alignment with the tilt deck to facilitate loading machines and the like on the deck, especially machines with low clearance.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a side view of an embodiment of an apparatus of the present invention shown in the transport position;

FIG. 2 is a side view of the embodiment of FIG. 1 shown with the deck tilted down such that the ramp rests on the ground;

FIG. 3 is a side view of the embodiment of FIG. 1 shown with the deck tilted down such that the rear end thereof rests on a leg member, and the ramp is aligned with the deck;

FIG. 4 is a side view of the ramp latch of the embodiment of FIG. 1 in the locked position;

FIG. 5 is a side view of the ramp latch of FIG. 4 in the released position, with the ramp in the inclined position;

FIG. 6 is a side view of the ramp latch of FIG. 4 in the released position, with the ramp in the aligned position;

FIG. 7 is a rear perspective view of the ramp latch of FIG. 4 in the locked position;

FIG. 8 is a bottom perspective view of the ramp and ramp latch in the locked position.

### DETAILED DESCRIPTION OF THE ILLUSTRATED EMBODIMENTS

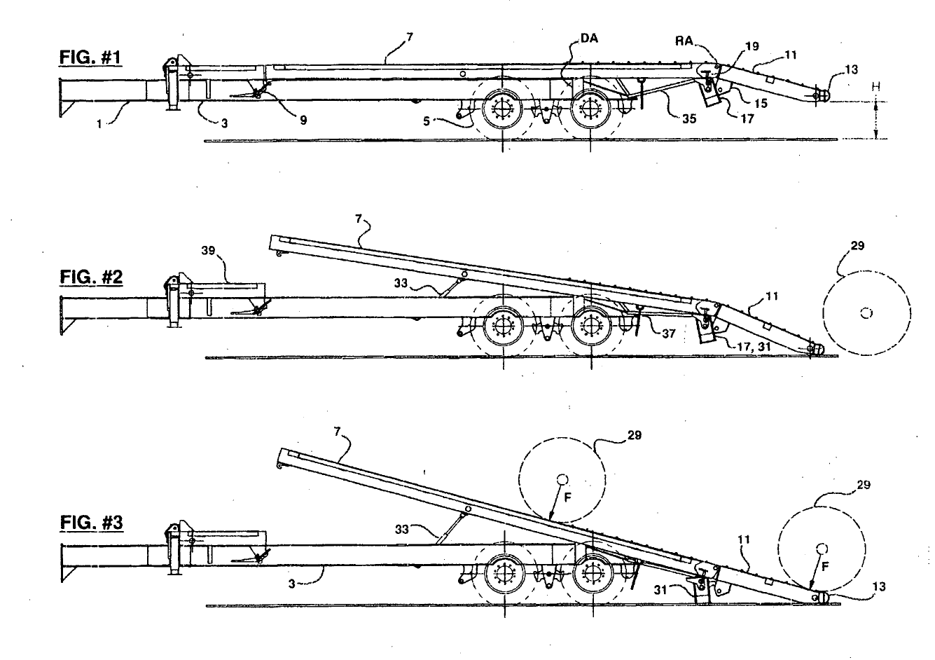

FIGS. 1-3 illustrate a side view of a tilt deck vehicle apparatus 1. The illustrated vehicle is a trailer, however it is contemplated that the tilt deck of the present invention could be used on a truck or like vehicle as well. The apparatus 1 comprises a frame 3 supported on wheels 5 for travel along the ground in an operating travel direction T. A tilt deck 7 is pivotally attached at a middle portion thereof to a rear portion of the frame 3 about a deck pivot axis DA. The deck pivot axis DA illustrated is located slightly forward of the rear end of the frame 3, and on the top side of the frame 3. The rear end of the frame slopes down to allow the deck 7 to tilt downward rearward of the deck pivot axis DA.

The tilt deck 7 is supported on the frame 7 for transport on the wheels 5 when the tilt deck 7 is in the horizontal transport position shown in FIG. 1, and a deck latch 9 is operative to selectively lock the tilt deck 7 to the frame 3 in the transport position.

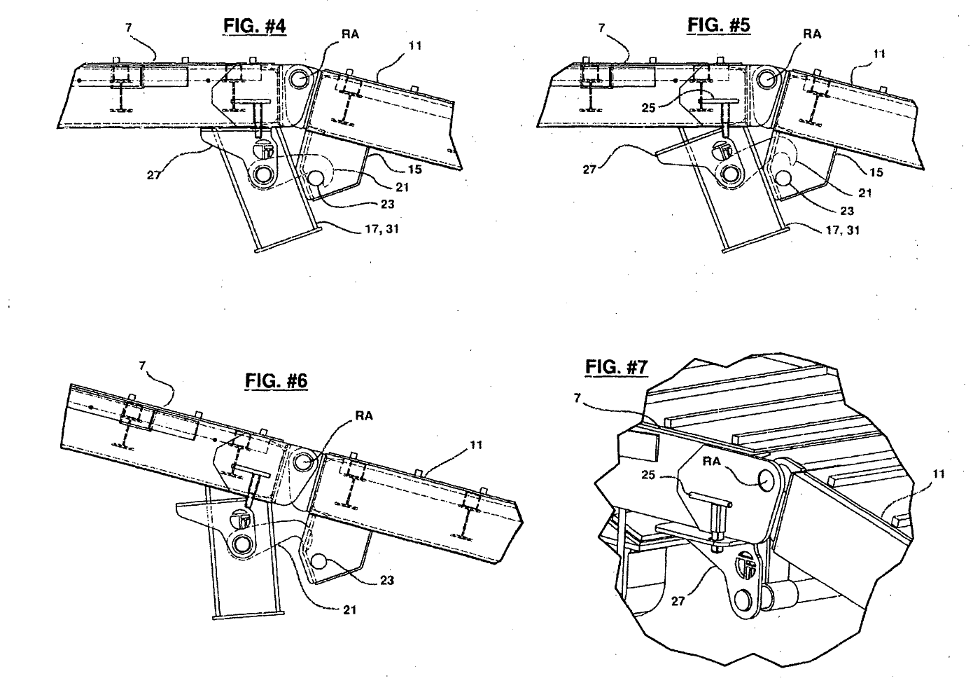

A ramp 11 is pivotally attached at the front end thereof to the rear end of the tilt deck 7 about a ramp pivot axis RA. The ramp 11 is movable from an inclined position, where the ramp 11 slopes downward from the front end thereof such that a rear end of the ramp 11 is a desired distance H above the ground, to an aligned position as illustrated in FIG. 3 where a top surface of the ramp 11 is substantially aligned with a top surface of the tilt deck 7. A rear impact guard 13 is attached to the rear end of the ramp 11 in the illustrated apparatus 1.

In the inclined position a ramp bracket 15 fixed to the ramp 11 bears against a ramp stop 17 as illustrated in FIG. 4, such that the ramp is prevented from pivoting downward past the selected inclined position where the rear impact guard 13 is at the required height H. A ramp latch 19, as illustrated in FIGS. 4-8, is operative to selectively lock the ramp 11 to the tilt deck 7 in the inclined position of FIG. 1. The ramp latch comprises hooks 21 that engage a rod 23 extending between the ramp brackets 15 and prevent the ramp 11 from pivoting upward about the ramp pivot axis RA when in the locked position of FIGS. 4, 7, and 8. Thus the rear impact guard 13 is secured in the required position, and is prevented from moving up and down during a crash from the rear.

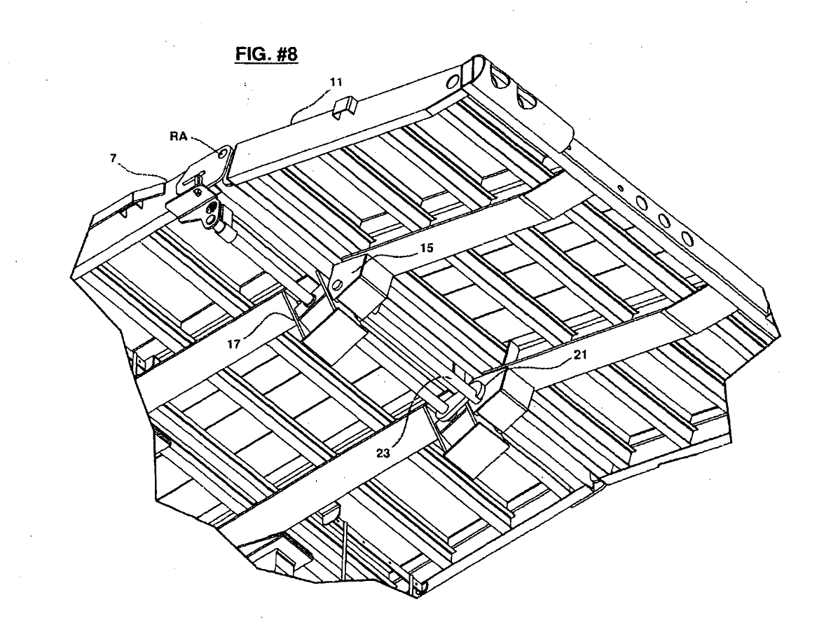

Moving lock release 25 upward allows the hook control 27 to be turned, as illustrated in FIG. 5, to move the hooks 21 up and out of engagement with the rod 23, thereby releasing the ramp latch 19 and allowing the ramp 11 to move up to the aligned position of FIG. 6. The hook control 27 can be locked in the released position by moving the lock release 25 down behind the hook control as seen in FIGS. 5 and 6.

The frame 3, tilt deck 7, and ramp 11 are configured such that when the deck latch 9 is released, the rear end of the tilt deck 7 moves down from the transport position of FIG. 1 until the rear end of the ramp 11 rests on the ground as seen in FIG. 2. The tilt deck 7, and ramp 11 are balanced about the deck pivot axis DA so that there is slightly more weight rearward of the deck pivot axis DA and so the front end of the deck 7 will go up, and the rear end will go down until the ramp 11 contacts the ground.

When the ramp latch 19 is released, the deck 7 and ramp 11 will remain in the position of FIG. 2. Since the weight of the ramp 11 is resting on the ground, no further downward movement of the deck 7 or ramp 11 will occur when the ramp latch 19 is released, however the rear end of the tilt deck 7 can move downward such that the ramp 11 can move to the aligned position of FIG. 3 in response to a downward force exerted on the ramp 11 by a machine, schematically illustrated by a wheel 29, being moved onto the ramp 11 for loading. The machine will typically be rolled onto the ramp 11 on wheels or tracks, but could also slide on skids or the like. Since the deck 7 and ramp 11 are aligned, low clearance machines can be readily loaded without the risk of hanging up on a corner between the ramp 11 and deck 7.

It is contemplated that upward movement stops could be provided between the ramp 11 and the deck 7 to prevent upward movement of the ramp past the aligned position of FIG. 3, however the illustrated apparatus 1 includes leg member 31 extending downward from a rear portion of the tilt deck 7, and configured such that when a bottom end of the leg member 31 is resting on the ground, the ramp 11 is in the aligned position of FIG. 3, and no upward movement stop is required. The leg member 31 provides a strong and simple support to maintain the deck 7 and ramp 11 in alignment. Conveniently the leg member 31 also provides the ramp stop 17 against which the ramp bracket bears when in the inclined position of FIG. 1.

In order to provide a smooth operation for the apparatus, the illustrated embodiment also includes a retarding mechanism operative to slow movement of the tilt deck 7 with respect to the frame 3. The retarding mechanism comprises a hydraulic cylinder 33 attached between the tilt deck 7 and the frame 3. The hydraulic cylinder 33 is passive and has no pressurized fluid lines connected thereto. The hydraulic cylinder 33 is filled with hydraulic fluid and there is an orifice in the piston of the cylinder. The hydraulic cylinder 33 is positioned and configured such that as the rear end of the tilt deck 7 moves down, hydraulic fluid in the hydraulic cylinder 33 on the upper side of the piston passes through the orifice to the opposite lower side of the piston, and as the rear end of the tilt deck 7 moves up, the hydraulic fluid on the lower side of the piston passes through the orifice to the upper side of the piston.

The retarding mechanism thus does not exert any actual force between the deck 7 and frame 11 until the deck 7 starts to move with respect to the frame 3. At that time the hydraulic fluid moving through restriction of the orifice exerts a retarding force on the deck. Thus even a small weight difference between the portion of the deck 7 forward of the deck pivot axis DA and the portion of the deck 7 and attached ramp 11 rearward of the deck pivot axis DA will still cause the rear end of the deck 7 to move downward, but the movement will be slowed by the hydraulic cylinder 33. Adjusting the size of the orifice will allow the speed of movement to be selected at a desired rate. A metering valve could be provided to allow for convenient adjustment of the speed of movement.

As a machine is moved up the ramp 11 and onto the deck 7, the weight of the machine will move forward to an over center point where the front of the tilt deck 7 will move down. Downward movement of the deck 7 is retarded by the hydraulic cylinder 33 such that the deck and machine drop gently back to the transport position. The hydraulic cylinder 33 thus allows the machine to be moved up onto the tilt deck 7 without attempting to stop the machine when the over center point is reached to prevent the deck 7 from moving down too fast.

While the deck and ramp latches 9, 19 can be operated individually, it is contemplated that they could be connected by a linkage 35, schematically illustrated in FIG. 1, such that releasing one of the deck latch 9 and the ramp latch 11 also releases the other. It is also contemplated that a trip mechanism 37 could be provided operative to release the ramp latch 19 as the rear end of the tilt deck 7 moves down from the transport position, as schematically illustrated in FIG. 2.

The illustrated vehicle apparatus 1 includes a fixed deck 39 attached to the frame 3 forward of the tilt deck 7. The fixed deck 39 enlarges the load bearing surface of the vehicle apparatus 1, such that more or larger machines can be transported.

Thus a rear impact guard and ramp on a tilt deck vehicle apparatus 1 are provided by the present invention. A machine is loaded on the vehicle apparatus I for transport by the steps of releasing the deck latch 9 such that the rear end of the tilt deck 7 moves down from the transport position of FIG. 1 until the rear end of the ramp 11 rests on the ground as shown in FIG. 2. Downward movement of the tilt deck 7 is retarded by the hydraulic cylinder 33. The ramp latch 19 is released, and can be released before, after, or simultaneously with release of the deck latch 9.

The machine to be loaded is moved onto the ramp 11 such that the machine wheel 29 exerts a downward force F on the ramp 11 and moves the ramp 11 to the aligned position shown in FIG. 3. The machine is moved up the ramp 11 onto the tilt deck 7 such that a weight of the machine wheel 29 on the tilt deck 7 moves past the deck pivot axis and over centers the deck 7 and causes the tilt deck 7 to move to the transport position of FIG. 1, and downward movement of the front end of the tilt deck 7 is retarded by the hydraulic cylinder 33. Once the tilt deck 7 is in the transport position of FIG. 1, the deck latch and ramp latch are locked. The machine can maneuvered ahead onto the fixed deck 39 if desired, and the machine is secured to the decks 7, 39 and frame 3 as required.

When unloading the machine, the deck and ramp latches 9, 19 are released and the machine is moved slowly rearward. As the machine moves rearward the deck 7 tilts downward and the ramp moves up to the aligned position, and the machine is rolled off the ramp 11. When the machine is off the ramp 11, the rear end of the deck 7 will typically move up until the ramp 11 is in the inclined position of FIG. 2, at which point the weight of the ramp 11 will prevent further movement, with the balanced configuration described above. The driver then walks up the tilt deck, and the balance of the deck 7 and ramp 11 is such that the weight of the driver at the forward end of the tilt deck 7 will cause the front end of the deck 7 to move down to the transport position of FIG. 1. The driver then locks the deck and ramp latches 9, 19, and is ready for travel with the rear impact guard 13 in the desired vertical location.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A tilt deck vehicle apparatus comprising:
a frame supported on wheels for travel along the ground in an operating travel direction;
a tilt deck pivotally attached at a middle portion thereof to a rear portion of the frame about a deck pivot axis such that the tilt deck is supported on the frame for transport on the wheels when the tilt deck is in a substantially horizontal transport position;
a deck latch operative to selectively lock the tilt deck to the frame in the transport position;
a ramp pivotally attached at a front end thereof to a rear end of the tilt deck about a ramp pivot axis and movable from an inclined position, where the ramp slopes downward from the front end thereof such that a rear end of the ramp is a desired distance above the ground, to an aligned position where a top surface of the ramp is substantially aligned with a top surface of the tilt deck;
a ramp latch operative to selectively lock the ramp to the tilt deck in the inclined position;
wherein the frame, tilt deck, and ramp are configured such that when the deck latch is released the rear end of the tilt deck moves down from the transport position until the rear end of the ramp rests on the ground; and
wherein when the ramp latch is released, the rear end of the tilt deck can move downward such that the ramp can move to the aligned position in response to a downward force exerted on the ramp.

2. The apparatus of claim 1 further comprising a leg member extending downward from a rear portion of the tilt deck, and configured such that when a bottom end of the leg member is resting on the ground, the ramp is in the aligned position.

3. The apparatus of claim 1 further comprising a retarding mechanism operative to slow movement of the tilt deck with respect to the frame.

4. The apparatus of claim 3 wherein the retarding mechanism comprises a hydraulic cylinder attached between the tilt deck and the frame, with an orifice in a piston of the cylinder, the hydraulic cylinder configured such that as the rear end of the tilt deck moves down, hydraulic fluid in the hydraulic cylinder on a first side of the piston passes through the orifice to an opposite second side of the piston, and such that as the rear end of the tilt deck moves up, hydraulic fluid in the hydraulic cylinder on the second side of the piston passes through the orifice to the first side of the piston.

5. The apparatus of claim 1 wherein the deck latch and ramp latch arc connected such that releasing one of the deck latch and the ramp latch also releases the other of the deck latch and the ramp latch.

6. The apparatus of claim 1 comprising a trip mechanism operative to release the ramp latch as the rear end of the tilt deck moves down front the transport position.

7. The apparatus of claim 1 further comprising a fixed deck attached to the frame forward of the tilt deck.

8. A method of providing a rear impact guard and ramp on a tilt deck vehicle, the method comprising:
providing a frame supported on wheels for travel along the ground in an operating travel direction;
providing a tilt deck pivotally attached at a middle portion thereof to a rear portion of the frame about a deck pivot axis such that the tilt deck is supported on the frame for transport on the wheels when the tilt deck is in a substantially horizontal transport position;
providing a deck latch operative to selectively lock the tilt deck to the frame in the transport position;
providing a ramp pivotally attached at a front end thereof to a rear end of the tilt deck about a ramp pivot axis and movable from an inclined position, where the ramp slopes downward from the front end thereof, to an aligned position where a top surface of the ramp is substantially aligned with a top surface of the tilt deck;
providing a rear impact guard at a rear end of the ramp and configuring the ramp such that the rear impact guard is a desired distance above the ground;
providing a ramp latch operative to selectively lock the ramp to the tilt deck in the inclined position;
configuring the frame, tilt deck, and ramp such that when the deck latch is released the rear end of the tilt deck moves down from the transport position until the rear end of the ramp rests on the ground; and
wherein releasing the ramp latch allows the rear end of the tilt deck to move downward such that the ramp can move to the aligned position in response to a downward force exerted on the ramp.

9. The method of claim 8 further comprising loading a machine on the tilt deck for transport by the steps of:
releasing the deck latch such that the rear end of the tilt deck moves down from the transport position until the rear end of the ramp rests on the ground, and retarding downward movement of the tilt deck;
releasing the ramp latch;
moving the machine onto the ramp such that the machine exerts a downward force on the ramp and moves the ramp to the aligned position;
moving the machine up the ramp onto the tilt deck such that a weight of the machine on the tilt deck causes the tilt deck to move to the transport position, and retarding movement of the tilt deck toward the transport position;
locking the deck latch and ramp latch, and securities the machine to the tilt deck.

10. The method of claim 8 further comprising providing a leg member extending downward from a rear portion of the tilt deck, and configuring the leg member such that when a bottom end of the leg member is resting on the ground, the ramp is in the aligned position.

11. The method of claim 8 wherein movement of the tilt deck is retarded by providing a hydraulic cylinder attached between the tilt deck and the frame, with an orifice in a piston of the cylinder, and configuring the hydraulic cylinder such that as the rear end of the tilt deck moves down, hydraulic fluid in the hydraulic cylinder on a first side of the piston passes through the orifice to an opposite second side of the piston, and such that as the rear end of the tilt deck moves up, hydraulic fluid in the hydraulic cylinder on the second side of the piston passes through the orifice to the first side of the piston.

12. The method of claim 8 further comprising connecting the deck latch and ramp latch such that releasing one of the deck latch and the ramp latch also releases the other of the deck latch and the ramp latch.

13. The method of claim 8 further comprising providing a trip mechanism operative to release the ramp latch as the rear end of the tilt deck moves down from the transport position.

14. The method of claim 8 further comprising providing a fixed deck attached to the frame forward of the tilt deck lo enlarge a load bearing surface of the vehicle.
